(19) United States
(12) Patent Application Publication
(10) Pub. No.: US 2026/0350924 A1
(43) Pub. Date: Nov. 5, 2026

(54) INFORMATION PROCESSING APPARATUS, INFORMATION PROCESSING METHOD, AND COMPUTER-READABLE NON-TRANSITORY STORAGE MEDIUM

(71) Applicant: SONY GROUP CORPORATION, TOKYO (JP)

(72) Inventor: YASUNARI IKEDA, TOKYO (JP)

(21) Appl. No.: 19/105,053

(22) PCT Filed: Aug. 15, 2023
(86) PCT No.: PCT/JP2023/029484

§ 371 Date: Feb. 20, 2025

(30) Foreign Application Priority Data
Sep. 5, 2022 (JP) 2022-140626

(51) Int. Cl. G06T 17/20; G06T 13/40

(52) U.S. Cl. CPC G06T 17/205; G06T 13/40

(57) ABSTRACT

An information processing apparatus includes an oral mesh deformation unit. The oral mesh deformation unit fixes an upper vertex group of an oral mesh to a position of an upper jaw of a face mesh and deforms the oral mesh by moving a lower vertex group of the oral mesh in accordance with a motion of the lower jaw of the face mesh.

### FIELD

The present invention relates to an information processing apparatus, an information processing method, and a computer-readable non-transitory storage medium.

### BACKGROUND

A method for recording motion of a face by tracking a facial marker is known. By applying a tracked motion to a 3D model (face mesh) of a face of a computer graphics (CG) character, a facial animation is implemented. Linear Shell Deformation (LSD) is known as a deformation algorithm of a face mesh. When the LSD is performed by specifying a vertex (control point) of the face mesh that is a starting point of deformation, the vertex of the face mesh other than the control point is moved in a well-balanced manner.

### CITATION LIST

### Patent Literature

Patent Literature 1: JP 6766033 B2

### SUMMARY

### Technical Problem

Regarding expressions of facial portions such as wrinkles, eyes, lips, eyebrows, and eyelashes, techniques for generating a face mesh have been widely studied. On the other hand, there is room for improvement in the generation of the oral mesh that hits the inside of the mouth. The oral mesh is a part that is not visible from the outside when the mouth is closed, but can be confirmed when the mouth is opened in surprise or conversation. Accordingly, high-quality generation of the oral mesh can be a differentiating technique.

However, when the conventional method is applied to the oral mesh, the following problems occur. First, since many markers are of a sticking type, it is difficult to attach a marker in the oral cavity wetted with saliva or the like. Even if the marker can be arranged in the oral cavity, the marker may be shielded when the mouth is closed, and the control point may not be set. As a result, occurrence of protrusion of the oral mesh and adverse effects on appearance occur, and it is necessary for an artist with specialized knowledge for correction to manually correct these issues.

Therefore, the present disclosure proposes an information processing apparatus, an information processing method, and a computer-readable non-transitory storage medium capable of appropriately deforming an oral mesh without using a marker in an oral cavity.

### Solution to Problem

According to the present disclosure, an information processing apparatus is provided that comprise an oral mesh deformation unit that fixes an upper vertex group of an oral mesh to a position of an upper jaw of a face mesh and deforms the oral mesh by moving a lower vertex group of the oral mesh in accordance with a motion of a lower jaw of the face mesh. According to the present disclosure, an information processing method in which an information process of the information processing apparatus is executed by a computer, and a computer-readable non-transitory storage medium that stores a program causing a computer to perform the information process of the information processing apparatus, are provided.

### BRIEF DESCRIPTION OF DRAWINGS

FIG. 1 is a diagram illustrating an outline of character generation processing of the present disclosure.

FIG. 2 is a diagram illustrating an outline of a video production system.

FIG. 3 is a diagram illustrating an example of deformation processing of a base oral mesh.

FIG. 4 is a view illustrating an example of a jaw opening/closing estimation vertex group.

FIG. 5 is a view illustrating an example of a lip vertex group.

FIG. 6 is a view illustrating an example of an upper vertex group.

FIG. 7 is a view illustrating an example of a lower vertex group.

FIG. 8 is a view illustrating an example of an integrated model obtained by a method of the present disclosure.

FIG. 9 is a view illustrating an example of the integrated model obtained by the method of the present disclosure.

FIG. 10 is a diagram illustrating an example of a hardware configuration of an information processing apparatus.

### DESCRIPTION OF EMBODIMENTS

Hereinafter, an embodiment of the present disclosure will be described in detail with reference to the drawings. Note that in each of the following embodiments, the same parts are denoted by the same reference numerals, and redundant description will be omitted.

Note that the description will be given in the following order.
[1. Outline of character generation processing]
[2. Video production system]
[2-1. Marker position acquisition unit]
[2-2. Face mesh deformation unit]
[2-3. Mesh reading unit]
[2-4. Lower jaw parameter calculation unit]
[2-5. Oral mesh deformation unit]
[2-6. Mesh integration unit]
[3. Embodiment]
[4. Hardware configuration]
[5. Effects]

### 1. Outline of Character Generation Processing

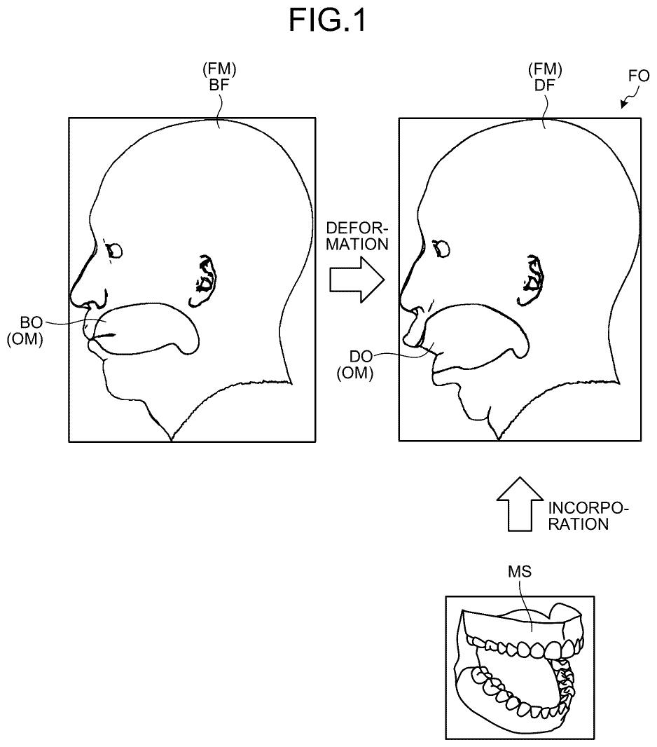

FIG. 1 is a diagram illustrating an outline of character generation processing of the present disclosure.

A CG character is generated by incorporating an oral mesh OM and an internal structure mesh MS into a face mesh FM. The face mesh FM, the oral mesh OM, and the internal structure mesh MS are configured as polygon meshes (hereinafter, it is simply referred to as a “mesh”). The mesh includes a plurality of vertices, and a plurality of sides and a plurality of surfaces obtained by connecting adjacent vertices. Although some words related to the mouth appear in the following description, the definition of each word is as follows.
Oral cavity: “Inside the mouth” as a human part, which is not related to CG.
Oral Mesh: a 3D model of a bag inside the mouth connecting the lips to the throat.
Internal structure mesh: 3D model of teeth, gums and tongue required for mouth representation.
Face mesh: a 3D model of a surface portion of a human face connected with an oral mesh at the lip portion.
Control point: a vertex that is a starting point of mesh deformation in LSD.

The face mesh FM is deformed on the basis of the tracking result of the facial marker. The oral mesh OM is deformed in accordance with the face mesh FM. The oral mesh OM is connected to the face mesh FM at the lip portion. Thus, the oral mesh OM is deformed in accordance with a motion of the lips. However, when deformation is performed without restriction in accordance with only a motion of the lips, deformation different from the actual deformation may occur. Accordingly, in the present disclosure, deformation accuracy is improved by adding a restriction condition simulating an actual motion of the oral cavity to the deformation processing of the oral mesh OM.

For example, an upper part of the oral cavity is connected to the vicinity of the maxilla, and a lower part of the oral cavity is connected to the mandible through the suprahyoid muscle group. The suprahyoid muscle group is a muscle that opens and closes the jaw in conjunction with the infrahyoid muscle group when the jaw is opened and closed, and basically does not greatly change in shape and pulls down the jaw by contraction. In the present disclosure, by imposing such a motion of the oral cavity as a restriction of deformation of the oral mesh OM, the oral mesh OM that simulates actual motion of the oral cavity is generated. Hereinafter, a specific description will be given.

In the following description, the face mesh FM before deformation serving as a base is referred to as a base face mesh BF, and the oral mesh OM before deformation serving as a base is referred to as a base oral mesh BO. Further, the face mesh FM after deformation is described as a deformed face mesh DF, and the oral mesh OM after deformation is described as a deformed oral mesh DO.

### 2. Video Production System

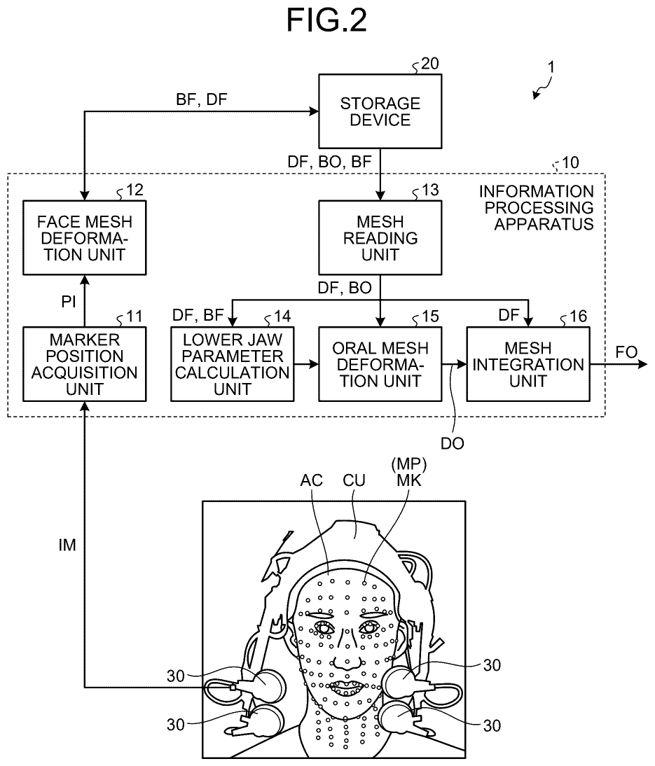

FIG. 2 is a diagram illustrating an outline of a video production system 1.

The video production system 1 is a system that produces a digital human using a facial marker tracking technology. The video production system 1 tracks motions of markers MK attached to the face of an actor AC. A plurality of marker points MP indicating attachment positions of the markers MK is set in advance on the face of the actor AC. The video production system 1 models the expression of the actor AC on the basis of relative motions between the markers MK (parts of the face defined as marker points MP).

In the present disclosure, the actor AC is not limited to a professional performer, and may include a general user. It should be noted that the actor AC in the present disclosure is a generic term for users who use a system that provides a digital human, and is not a term representing a user who executes a specific purpose using the digital human.

The video production system 1 acquires a face mesh FM (base face mesh BF) of a CG character as a base. The video production system 1 applies the modeled expression to the base face mesh BF to generate an expression model (deformed face mesh DF). In the example of FIG. 1, the face mesh FM of the actor AC is used as the face mesh of the CG character, but the modeled expression may be applied to the face mesh FM of another CG character.

A camera unit CU for capturing an image of the actor AC is attached to the head of the actor AC on which the markers MK are attached. For example, a plurality of cameras 30 in which visual fields are partially superimposed is fixed to the camera unit CU. The camera unit CU captures an image of the entire attachment region of the markers MK using the plurality of cameras 30. The plurality of cameras 30 is synchronously driven and monitor motions of each marker MK. Motions of the marker points MP are detected as motions of the markers MK. Motions of the face are modeled on the basis of the positional relationship between the marker points MP.

The video production system 1 includes an information processing apparatus 10, a storage device 20, and a camera 30.

The camera 30 is fixed in front of the actor AC as an attachment target of the markers MK. While attachment work of the markers MK is being performed, the camera 30 captures the face of the actor AC at a predetermined frame rate, and sequentially outputs a face image IM of the actor AC to the information processing apparatus 10.

The storage device 20 stores information of the face mesh FM, the oral mesh OM, and the internal structure mesh MS of the actor AC. The storage device 20 stores a base 3D model (base mesh) before deformation for each model. For example, the base mesh is a 3D model representing a shape at the time of being expressionless.

The information processing apparatus 10 deforms the base mesh on the basis of position information of the tracked markers MK. The storage device 20 stores various types of information such as algorithms and parameters necessary for the base mesh deformation processing. The storage device 20 also stores a 3D model (deformed mesh) obtained by deforming the base mesh.

For example, the storage device 20 stores the face mesh FM of the actor AC as the base face mesh BF. The storage device 20 stores the oral mesh OM of the actor AC as a base oral mesh BO. The base face mesh BF and the base oral mesh BO are created by common CG software.

The information processing apparatus 10 deforms the base face mesh BF on the basis of the position information of the tracked markers MK. The information processing apparatus 10 deforms the base oral mesh BO in accordance with the base face mesh BF after deformation (deformed face mesh DF). The information processing apparatus 10 incorporates the base oral mesh after deformation (deformed oral mesh DO) into the deformed face mesh DF. Thus, the information processing apparatus 10 generates an integrated mesh FO in which the deformed face mesh DF and the deformed face mesh DF are integrated.

The information processing apparatus 10 performs similar deformation processing on the internal structure mesh MS. The information processing apparatus 10 deforms the internal structure mesh MS in accordance with the deformed oral mesh DO, and incorporates the internal structure mesh MS after deformation into the deformed oral mesh DO. The information processing apparatus 10 outputs the integrated mesh FO including the internal structure mesh MS as a final 3D model of the character.

For example, the information processing apparatus 10 includes a marker position acquisition unit 11, a face mesh deformation unit 12, a mesh reading unit 13, a lower jaw parameter calculation unit 14, an oral mesh deformation unit 15, and a mesh integration unit 16.

### 2-1. Marker Position Acquisition Unit

The marker position acquisition unit 11 acquires three-dimensional positions of a plurality of markers MK attached to the face of the actor AC from the face image IM of the actor AC. The marker position acquisition unit 11 outputs the measured three-dimensional positions of the plurality of markers MK as marker position information PI.

In order to acquire the positions of the markers MK, a known motion capture system or a facial capture system using a head mounted camera can be used. In the example of FIG. 2, a compound-eye head mounted camera equipped with a plurality of cameras 30 is used as the camera unit CU. In a case where the positions of the markers MK are acquired by the head mounted camera, since the camera 30 and the head are fixed, the marker position acquisition unit 11 can acquire three-dimensional positions of the markers MK that do not depend on a motion of the head.

In a case where the motion capture system is used to acquire the positions of the markers MK, the acquired three-dimensional position is a position on a world coordinate system, and thus is a position including movement of the head. In order to implement the facial animation, it is necessary to cancel a motion of the head in order to obtain only a motion of the part of the face. Thus, by attaching markers for head position estimation on the head, obtaining 6 DoF (translation/rotation parameter) of the head by a motion capture system, and applying an inverse matrix of the obtained 6 DoF to the positions of the markers MK, it is possible to acquire the positions of the markers MK in which the motion of the head is canceled.

### 2-2. Face Mesh Deformation Unit

The face mesh deformation unit 12 deforms the base face mesh BF on the basis of the marker position information PI. As a method of deforming the base face mesh BF, a known method can be adopted.

For example, the face mesh deformation unit 12 aligns the plurality of markers MK detected by the marker position acquisition unit 11 with respect to the base face mesh BF. The position of a marker MK defined in the marker position information PI is represented by a coordinate system (system coordinate system) of the motion capture system or the facial capture system. Thus, the face mesh deformation unit 12 converts the position (coordinates) of each marker MK expressed in the system coordinate system into a position expressed in a coordinate system (model coordinate system) of the base face mesh BF.

For example, iterative closet point (ICP) is used for coordinate conversion. ICP is an algorithm for alignment between two different pieces of shape data. In the ICP, rigid body deformation (translation, rotation, and enlargement) can be handled, but non-rigid body deformation such as a difference in expression cannot be handled. Thus, it is desirable that the actor AC make the same expression as the expression of the base face mesh BF and align the plurality of markers MK with the base face mesh BF using the marker position information PI acquired at that time.

The face mesh deformation unit 12 acquires the positions of the markers MK aligned with the base face mesh BF as the positions of the marker points MP. The face mesh deformation unit 12 detects the displacement of the marker point MP from the initial position for each marker point MP. The initial position is the position of the marker point MP registered in the base face mesh BF. The face mesh deformation unit 12 uses each marker point MP as a control point, and deforms the entire face by LSD on the basis of the displacement of each marker point MP from the initial position. The face mesh deformation unit 12 outputs the deformed base face mesh BF as a deformed face mesh DO.

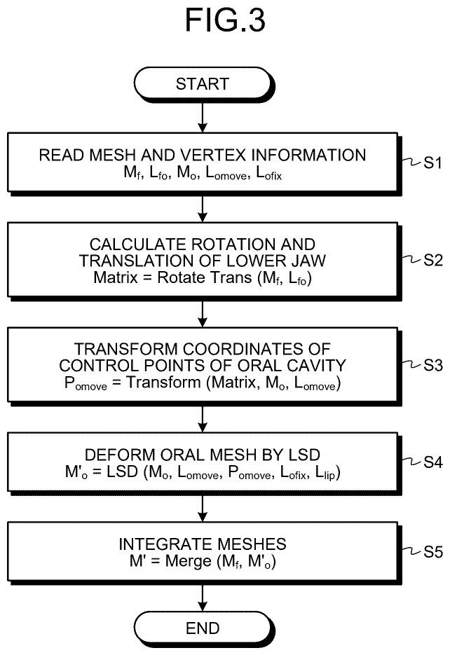

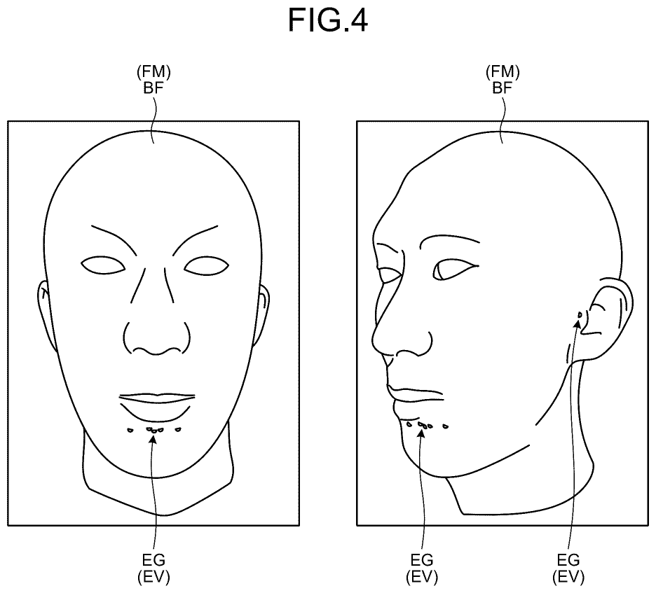

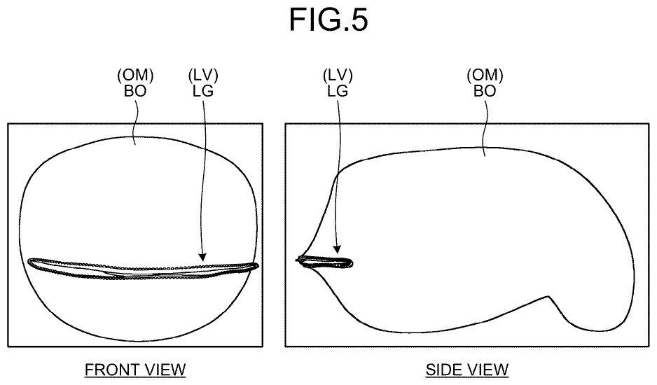

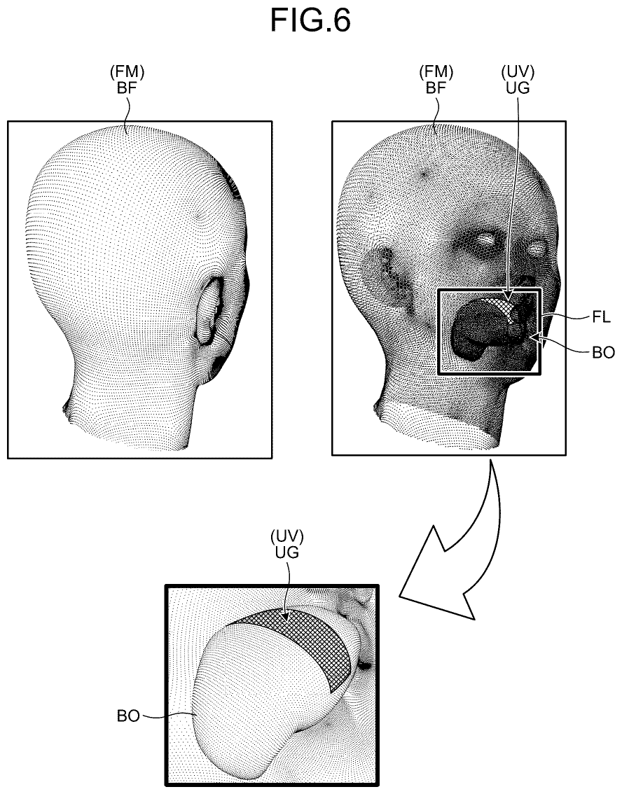

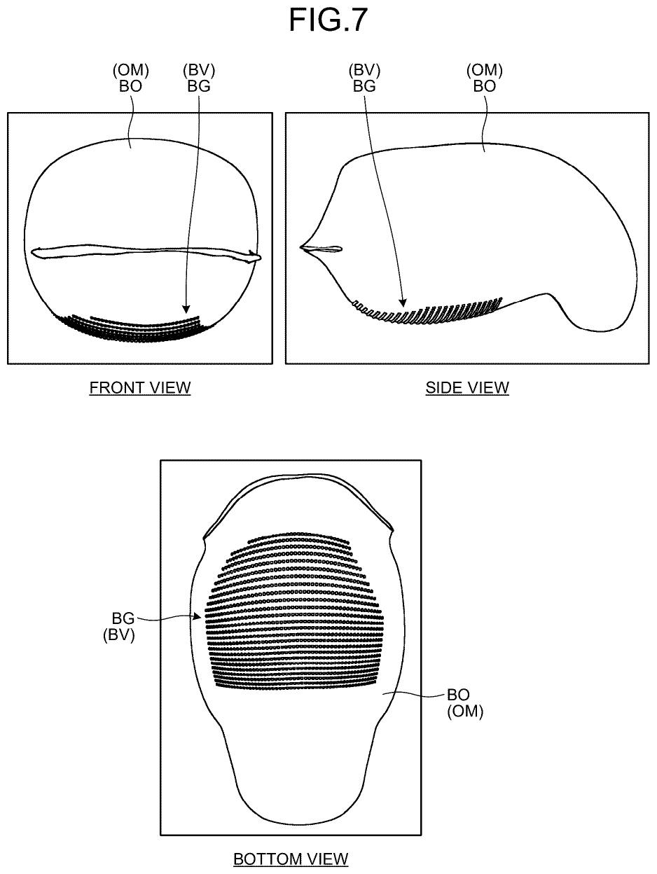

The information processing apparatus 10 performs deformation processing of the base oral mesh BO on the basis of the coordinate information of the deformed face mesh DO. FIG. 3 is a diagram illustrating an example of deformation processing of the base oral mesh BO. Hereinafter, configurations of the mesh reading unit 13, the lower jaw parameter calculation unit 14, the oral mesh deformation unit 15, and the mesh integration unit 16 will be described with reference to FIG. 3. Reference numerals in FIG. 3 indicate the following.
M_{f}: data of the deformed face mesh DF.
L_{f}: list of vertex group (jaw opening/closing estimation vertex group EG: see FIG. 4) for calculating the position of control point group of the deformed oral mesh DO from the deformed face mesh DF.
Mₒ: data of the base oral mesh BO.
Lₒₘₒᵥₑ: list of control point groups (lower vertex group BG: see FIG. 7) of the oral mesh OM serving as the operation unit.
L_{ofix}: list of control point groups (upper vertex group UG: see FIG. 6) of the oral mesh OM serving as the fixing portion.
Matrix: a function representing the rotational and translational motions of the lower jaw.
Pₒₘₒᵥₑ: data of the lower vertex group BG of the deformed oral mesh DO.
Lₒₗᵢₚ: list of control point groups (lip vertex group LG: see FIG. 5) of the oral mesh OM located at the lip portion.
Mₒ′: data of the deformed oral mesh DO.
M′: data of the integrated mesh FO.

### 2-3. Mesh Reading Unit

The mesh reading unit 13 reads the base face mesh BF, the deformed face mesh DF (“M_{f}”) , and the base oral mesh BO (“Mₒ”) from the storage device 20. The mesh reading unit 13 reads, from the storage device 20, a list of vertex groups (“L_{fo}”) used for lower jaw posture estimation processing and a list of control point groups (“Lₒₘₒᵥₑ”, “L_{ofix}”, and “Lₒₗᵢₚ”) used for the deformation processing of the base oral mesh BO. An ID of each vertex is defined in the list. The mesh reading unit 13 reads a list of each vertex group as vertex information (step S1).

In the present disclosure, in order to perform deformation imitating an actual motion of the oral cavity, which vertex of the base oral mesh BO is set as a control point and what kind of restriction is applied to which control point are determined in advance. An algorithm reflecting a restriction condition of each control point is applied to the deformation processing of the base oral mesh BO. The restriction condition is determined on the basis of the boundary condition obtained from the actual connection relationship between the jawbone and the oral cavity.

For example, a lip vertex group, an upper vertex group, and a lower vertex group are defined in the list of control point groups used for the deformation processing of the base oral mesh BO. FIG. 5 is a view illustrating an example of the lip vertex group LG. FIG. 6 is a view illustrating an example of the upper vertex group UG. FIG. 7 is a view illustrating an example of the lower vertex group BG. The view on the upper right side of FIG. 6 is a view visualizing the oral cavity portion (indicated by a frame FL) by making the base face mesh BF illustrated in the view on the upper left side of FIG. 6 transparent.

The lip vertex group LG includes a plurality of vertices (lip vertices LV) located at the lip portion of the oral mesh OM. The lip vertex group LG is a control point group for deforming the oral mesh OM according to a motion of the lip portion of the face mesh FM. The lip vertex group LG is set to implement the structural restriction that the deformed oral mesh DO is connected to the deformed face mesh DF at the lip portion. By using the lip vertex group LG as the control point group, a motion of the face mesh FM can be reflected in the oral mesh OM.

The upper vertex group UG includes a plurality of vertices (upper vertices UV) located at the top of the oral mesh OM. The upper vertex group UG is a vertex group that explicitly fixes a motion of the upper part of the oral mesh OM. The upper vertex group UG is set to implement a structural restriction that the upper part of the oral cavity is fixed near the maxilla. Thus, the upper vertex group UG includes a vertex group of a part corresponding to a coupling portion between the upper jaw and the oral mesh OM.

Referring to the structure of the human body (Valerie L. Winslow, “Classic Human Anatomy in Motion”, Maar-sha, 2018), the upper part of the oral cavity is actually connected to the vicinity of the skull, and does not move except for a motion of moving the entire skull, such as a motion of shaking the neck or tilting the neck. This feature can be imitated by using the upper vertex group UG as a fixed vertex group.

The lower vertex group BG includes a plurality of vertices (lower vertex BV) located at a lower part of the oral mesh OM. The lower vertex group BG is a vertex group that operates the oral mesh OM in conjunction with a motion of the lower jaw. The lower vertex group BG is set to implement the structural restriction that the lower part of the oral cavity is connected to the mandible through the suprahyoid muscle group.

Thus, the lower vertex group BG includes a vertex group of a part corresponding to a coupling portion between the lower jaw and the oral mesh OM.

The lower vertex group BG plays a central role in the deformation of the oral mesh OM. The lower vertex group BG moves in conjunction with a motion of the lower jaw to deform the oral mesh OM. Referring to the structure of the human body, a part corresponding to the lower part of the oral cavity is a region called a suprahyoid muscle group. The suprahyoid muscle group is located between the back side of the tongue and the lower jaw, and opens and closes the jaw in conjunction with the infrahyoid muscle group when the jaw is opened and closed. Basically, the shape of the suprahyoid muscle group does not change greatly, and the jaw is pulled down by slightly contracting. The lower vertex group BG includes a vertex group of a part corresponding to the suprahyoid muscle group. The shape of the oral mesh OM when the jaw is opened and closed can be reproduced by imparting a motion simulating a motion of the suprahyoid muscle group to the lower vertex group BG.

In the list of vertex groups used for the posture estimation processing of the lower jaw, a jaw opening/closing estimation vertex group is defined. FIG. 4 is a view illustrating an example of a jaw opening/closing estimation vertex group EG. The jaw opening/closing estimation vertex group EG is a vertex group for estimating six degrees of freedom (rotation and translation) at the time of opening/closing the jaw from the deformed face mesh DO. The jaw opening/closing estimation vertex group EG includes one or more vertices located on the upper jaw and one or more vertices located on the lower jaw.

For example, the jaw opening/closing estimation vertex group EG includes a plurality of vertices (jaw opening/closing estimation vertices EV) located at a site where movement of the skin is the smallest when the jaw is opened and closed. In the example of FIG. 4, seven vertices located under the lips and near the ears are selected as the jaw opening/closing estimation vertices EV from an analysis of the skeleton, an observation result of the face, and the like.

### 2-4. Lower Jaw Parameter Calculation Unit

The lower jaw parameter calculation unit 14 calculates a motion of the lower jaw on the basis of coordinate information of the jaw opening/closing estimation vertex group EG set in the face mesh FM (step S2).

For example, the lower jaw parameter calculation unit 14 acquires the base face mesh BF and the deformed face mesh DF from the mesh reading unit 13. The lower jaw parameter calculation unit 14 acquires coordinates of the jaw opening/closing estimation vertex group EG before the expression changes from the base face mesh BF on the basis of the vertex information (“L_{fo}”). On the basis of the vertex information (“L_{fo}”), the lower jaw parameter calculation unit 14 acquires coordinates of the jaw opening/closing estimation vertex group EG after the expression changes from the deformed face mesh DF.

The lower jaw parameter calculation unit 14 compares the coordinates of the jaw opening/closing estimation vertex group EG before the expression changes with the coordinates of the jaw opening/closing estimation vertex group EG after the expression changes. The lower jaw parameter calculation unit 14 calculates a motion of the lower jaw as a function (“Matrix”) indicating the rotation and translation operations of the lower jaw with respect to the upper jaw on the basis of the comparison result.

When considered from the viewpoint of the human body structure, opening and closing of the jaw is basically expressed by rotational movement. It is known that the lower jaw of a human rotates from a temporomandibular joint (TMJ) near an ear, and does not simply descend at the time of opening and closing, but obliquely descends toward a neck. However, the TMJ is a joint that allows movement other than rotation, and can perform back-and-forth movement or a motion in which only one side is removed.

The complexity of operation of the TMJ is also pointed out in the field of computer graphics. In the high-quality research, a motion of the jaw is expressed in six degrees of freedom (XYZ rotation and XYZ movement), and a motion of the TMJ is estimated including motions other than rotation (see the following Literatures 1 and 2).

[Literature 1] Gaspard Zoss, Derek Bradley, Pascal Berard, and Thabo Beeler, “An Empirical Rig for Jaw Animation”, ACM Transactions on Graphics, No. 37, Issue 4, Article 59, 2018. DOI: https://doi.org/10.1145/3197517.3201382

[Literature 2] Gaspard Zoss, Thabo Beeler, Markus Gross, and Derek Bradley, “Accurate Markerless Jaw Tracking for Facial Performance Capture”, ACM Transactions on Graphics, No. 38, Issue 4, Article 50, 2019. DOI: https://doi.org/10.1145/3306346.3323044

In the present disclosure, the XYZ axes are assumed to be a right-handed coordinate system and a coordinate system in which the X axis penetrates right and left TMJs. In the present disclosure, parameters of six degrees of freedom are estimated from the jaw opening/closing estimation vertex group EG. For the estimation, for example, a method called singular value decomposition (SVD) described in Literature 3 below is used.

Note that, for the purpose of simply expressing opening and closing of the mouth, expression can be made even with about three degrees of freedom (XY rotation and Z rotation), and the degree of freedom estimated changes depending on the required quality.

[Literature 3] Olga Sorkine-Hornung and Michael Rabinovich, “Least-Squares Rigid Motion Using SVD”, 2017. URL: https://igl.ethz.ch/projects/ARAP/svd rot.pdf

### 2-5. Oral Mesh Deformation Unit

The oral mesh deformation unit 15 transforms the coordinates of the lower vertex group BG of the base oral mesh BO using the function (“Matrix”) acquired from the lower jaw parameter calculation unit 14. For example, by applying a parameter of six degrees of freedom estimated by SVD to a target vertex using a commonly used matrix operation, the vertex can be moved to any position. The oral mesh deformation unit 15 acquires coordinates of the lower vertex group BG of the base oral mesh BO after the transformation as coordinates (“Pₒₘₒᵥₑ”) of the lower vertex group BG of the deformed oral mesh DO (step S3).

The oral mesh deformation unit 15 acquires the deformed face mesh DF from the mesh reading unit 13. The oral mesh deformation unit 15 calculates the coordinates of the lip vertex group LG and the upper vertex group UG of the deformed oral mesh DO on the basis of the coordinate information of the deformed face mesh DF. The oral mesh deformation unit 15 uses the calculated coordinates of the lip vertex group LG, the upper vertex group UG, and the lower vertex group BG as the coordinates of the control point group to perform the deformation processing of the base oral mesh BO by the LSD (step S4).

The deformation processing can be regarded as processing of “arranging surrounding vertices so as to achieve harmony when any movement is given to a specific vertex of a certain mesh”. As a method for implementing this, LSD is adopted in the present disclosure. The LSD is an algorithm that parameterizes connection information between vertices in an initial state for an input mesh, and performs deformation while maintaining an original shape to some extent when a certain vertex in the mesh moves.

For example, the oral mesh deformation unit 15 acquires the base oral mesh BO as the oral mesh OM to be deformed from the mesh reading unit 13. The oral mesh deformation unit 15 fixes the upper vertex group UG of the base oral mesh BO to the position of the upper jaw of the face mesh FM, and deforms the base oral mesh BO by moving the lower vertex group BG of the base oral mesh BO that is not explicitly fixed to the position of the lower jaw of the face mesh FM in accordance with a motion of the lower jaw of the face mesh FM. This deformation processing generates a deformed oral mesh DO (“Mₒ′”).

The oral mesh deformation unit 15 imparts a motion imitating a motion of the suprahyoid muscle group to the vertex group of the part corresponding to the suprahyoid muscle group in the lower vertex group BG. The oral mesh deformation unit 15 sets the lip vertex group LG moved in accordance with a motion of the lip portion of the face mesh FM and the lower vertex group BG moved in accordance with a motion of the lower jaw as a control point group. The oral mesh deformation unit 15 deforms the oral mesh OM by moving vertices (peripheral vertices) around the oral mesh OM around the control point group on the basis of the set control point group. Thus, a highly accurate deformed oral mesh DO is generated.

### 2-6. Mesh Integration Unit

The mesh integration unit 16 integrates the face mesh FM and the oral mesh OM with reference to the vertex group of the lip portion located at a boundary between the face mesh FM and the oral mesh OM. Thus, the mesh integration unit 16 generates the integrated mesh FO (“M′”) (step S5). For example, integration processing is performed by aligning the vertex group of the lip portion of the deformed oral mesh DO and the vertex group of the lip portion of the deformed face mesh DF and connecting the deformed oral mesh DO and the deformed face mesh DF.

Note that, in the present disclosure, the description has been given assuming that the face mesh FM includes only mesh information of a surface portion of the face and does not include mesh information of the oral cavity portion. However, when the face mesh FM includes the mesh information of the oral cavity portion, the integration processing is performed by replacing the mesh of the oral cavity portion of the deformed face mesh DF with the deformed oral mesh DO.

In the process of generating the integrated mesh FO, information of rotation and translation of the jaws is calculated. Using this information, internal structures (internal structure mesh MS) such as teeth, gums, and tongue can be disposed in the deformed oral mesh DO without discomfort. At this time, rotation and translation information for each 3D object constituting an internal structure is expressed by a matrix, and three-dimensional vertex coordinates and this matrix are multiplied, whereby the final position can be calculated. By incorporating the internal structure mesh MS by such a method, even a user who does not have special skills can arrange internal structures such as teeth, gums, and tongue at appropriate positions in each expression.

### 3. Embodiment

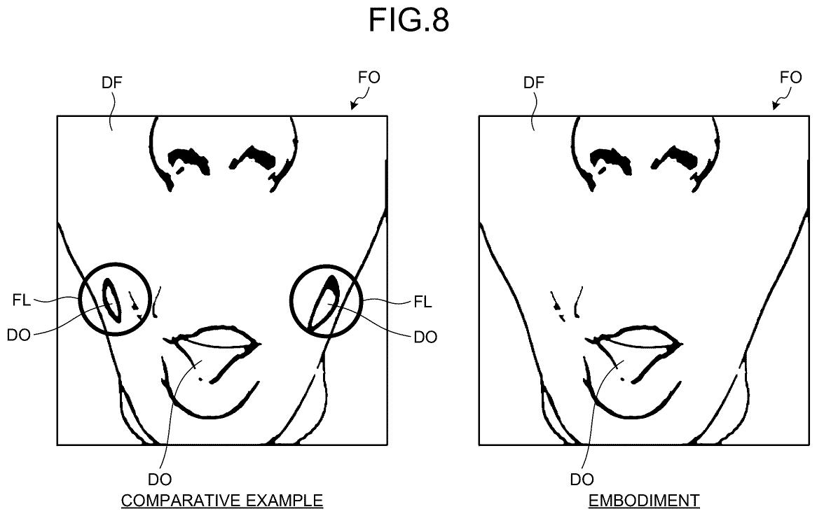

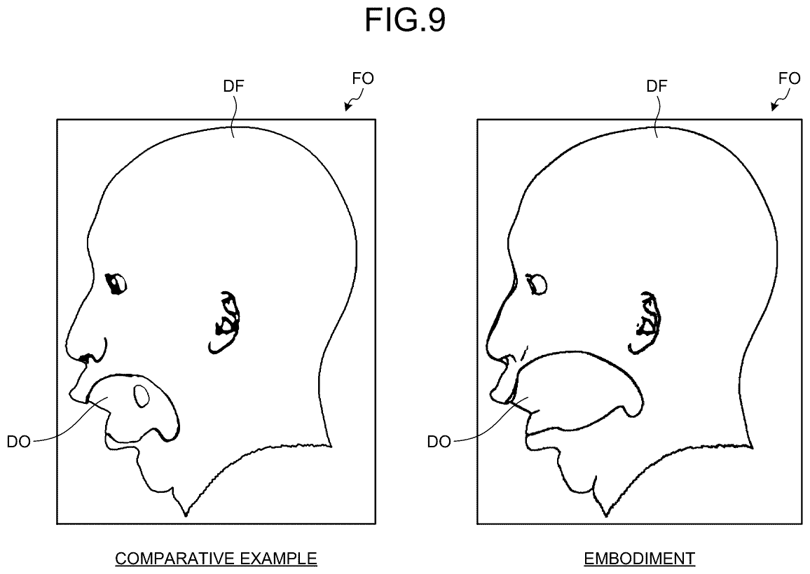

FIGS. 8 and 9 are diagrams illustrating an example of an integrated model obtained by the method of the present disclosure. FIG. 8 illustrates the integrated model FO of an expression with the mouth narrowed as a front view. FIG. 9 illustrates the integrated model FO of the same expression as in FIG. 8 as a cross-sectional view. In FIGS. 8 and 9, the view on the left side is a comparative example using the conventional method, and the view on the right side is an example using the method of the present disclosure.

In the example of FIG. 8, parts of the deformed oral mesh DO of the comparative example protrude to the outside of the deformed face mesh DF. In the embodiment, such protrusion does not occur. In the example of FIG. 9, it is possible to confirm what kind of difference occurs between the example and the comparative example in the mouth. In the comparative example, the base oral mesh BO is deformed without restriction in accordance with only motions of the lips, and consequently, the deformed oral mesh DO has a shape crushed forward. In the embodiment, the deformed oral mesh DO does not greatly change from the initial state (base oral mesh BO), and maintains the shape as a bag.

Such differences are created by introduced algorithms and anchoring sites. In the modification method of the present disclosure, an upper part, a lower part, and a front part of an oral cavity are operated, and other parts are deformed so as to approach the original shape. As a result, the upper part of the oral cavity is fixed at a place to be attached to the skull, and the shape of the oral mesh OM is determined by motions of the lower part of the oral cavity and the lips. In the comparative example, the entire shape of the oral mesh OM is determined with reference to the deformation of only the face surface, that is, only the lip portion. In the embodiment, as a result of imposing a restriction to operate some vertices above and below the oral cavity, the shape of the oral mesh OM is kept close to the actual structure.

### 4. Hardware Configuration

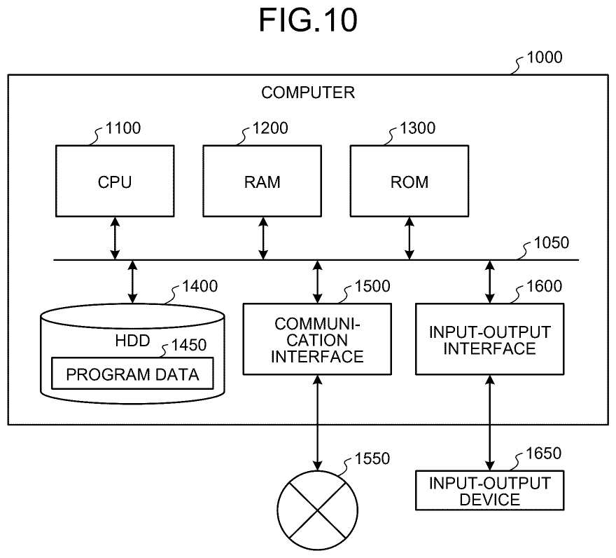

FIG. 10 is a diagram illustrating an example of a hardware configuration of the information processing apparatus 10.

Information processing of the information processing apparatus 10 is implemented by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input-output interface 1600. Each section of the computer 1000 is connected by a bus 1050.

The CPU 1100 operates on the basis of a program (program data 1450) stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a non-transitory computer-readable recording medium that non-transiently records a program executed by the CPU 1100, data used by the program, and the like. Specifically, the HDD 1400 is a recording medium that records the information processing program according to the embodiment as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input-output interface 1600 is an interface for connecting an input-output device 1650 and the computer 1000. For example, the CPU 1100 receives data from an input device such as a keyboard and a mouse via the input-output interface 1600. Further, the CPU 1100 transmits data to an output device such as a display device, a speaker, or a printer via the input-output interface 1600. Furthermore, the input-output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 10 according to the embodiment, the CPU 1100 of the computer 1000 implements the functions of the above-described units by executing the information processing program loaded on the RAM 1200. Further, the HDD 1400 stores an information processing program, various models, and various data according to the present disclosure. Note that the CPU 1100 reads the program data 1450 from the HDD 1400 and executes the program data 1450, but as another example, these programs may be acquired from another device via the external network 1550.

### 5. Effects

The information processing apparatus 10 includes the oral mesh deformation unit 15. The oral mesh deformation unit 15 fixes the upper vertex group UG of the oral mesh OM to the position of the upper jaw of the face mesh FM, and deforms the oral mesh OM by moving the lower vertex group BG of the oral mesh OM in accordance with a motion of the lower jaw of the face mesh FM. In the information processing method of the present disclosure, the processing of the information processing apparatus 10 is executed by the computer 1000. The computer-readable non-transitory storage medium of the present disclosure stores a program for causing the computer 1000 to implement processing of the information processing apparatus 10.

With this configuration, the oral mesh OM is deformed on the basis of the control points of the oral mesh OM calculated from the position of the lower jaw. The upper part of the oral mesh OM is fixed at the position of the upper jaw, and the lower part of the oral mesh OM moves in accordance with a motion of the lower jaw, but this motion simulates an actual motion of the oral cavity. Thus, the oral mesh OM can be appropriately deformed without using a marker in the oral cavity.

The upper vertex group UG includes a vertex group of a part corresponding to a coupling portion between the upper jaw and the oral mesh OM.

With this configuration, a structural restriction that the upper part of the oral cavity is fixed near the maxilla is implemented.

The lower vertex group BG includes a vertex group of a part corresponding to a coupling portion between the lower jaw and the oral mesh OM.

With this configuration, a structural restriction that the lower part of the oral cavity is connected to the mandible is implemented.

The lower vertex group BG includes a vertex group of a part corresponding to the suprahyoid muscle group.

With this configuration, a structural restriction that the lower part of the oral cavity is connected to the mandible through the suprahyoid muscle group is implemented.

The oral mesh deformation unit 15 imparts a motion imitating a motion of the suprahyoid muscle group to the vertex group of the part corresponding to the suprahyoid muscle group.

With this configuration, it is possible to deform the oral mesh OM reflecting the motion of the suprahyoid muscle group.

The oral mesh deformation unit 15 sets the lip vertex group LG moved in accordance with a motion of the lip portion of the face mesh FM and the lower vertex group BG moved in accordance with a motion of the lower jaw as a control point group. The oral mesh deformation unit 15 moves a peripheral vertex of the oral mesh OM around the set control point group.

With this configuration, the deformed oral mesh DO with high accuracy is generated.

The information processing apparatus 10 includes the mesh integration unit 16. The mesh integration unit 16 integrates the face mesh FM and the oral mesh OM with reference to the vertex group of the lip portion located at a boundary between the face mesh FM and the oral mesh OM.

With this configuration, the structural restriction that the deformed oral mesh DO is connected to the deformed face mesh DF at the lip portion is implemented.

The information processing apparatus 10 includes the lower jaw parameter calculation unit 14. The lower jaw parameter calculation unit 14 calculates a motion of the lower jaw on the basis of the coordinate information of the jaw opening/closing estimation vertex group EG set in the face mesh FM.

With this configuration, the motion of the lower jaw is easily calculated without using the marker in the oral cavity.

The jaw opening/closing estimation vertex group EG includes one or more vertices located on the upper jaw and one or more vertices located on the lower jaw.

With this configuration, the motion of the lower jaw is favorably detected on the basis of the positional relationship between the upper jaw and the lower jaw.

The jaw opening/closing estimation vertex group EG includes a plurality of vertices located at a site where movement of the skin is the smallest when the jaw is opened and closed.

With this configuration, the motion of the lower jaw is accurately calculated.

Note that the effects described in the present specification are merely examples and are not limited, and other effects may be provided.

### SUPPLEMENTARY NOTE

Note that the present technology can also employ the following configurations.
(1)

An information processing apparatus comprising:
an oral mesh deformation unit that fixes an upper vertex group of an oral mesh to a position of an upper jaw of a face mesh and deforms the oral mesh by moving a lower vertex group of the oral mesh in accordance with a motion of a lower jaw of the face mesh.
(2)

The information processing apparatus according to (1), wherein
the upper vertex group includes a vertex group of a part corresponding to a coupling portion between the upper jaw and the oral mesh.
(3)

The information processing apparatus according to (1) or (2), wherein
the lower vertex group includes a vertex group of a part corresponding to a coupling portion between the lower jaw and the oral mesh.
(4)

The information processing apparatus according to (3), wherein
the lower vertex group includes a vertex group of a part corresponding to a suprahyoid muscle group.
(5)

The information processing apparatus according to (4), wherein
the oral mesh deformation unit imparts a motion imitating a motion of the suprahyoid muscle group to the vertex group of the part corresponding to the suprahyoid muscle group.
(6)

The information processing apparatus according to any one of (1) to (5), wherein
the oral mesh deformation unit sets a lip vertex group moved in accordance with a motion of a lip portion of the face mesh and the lower vertex group moved in accordance with the motion of the lower jaw as a control point group, and moves a peripheral vertex of the oral mesh around the control point group.
(7)

The information processing apparatus according to any one of (1) to (6), comprising:
a mesh integration unit that integrates the face mesh and the oral mesh with reference to a vertex group of a lip portion located at a boundary between the face mesh and the oral mesh.
(8)

The information processing apparatus according to any one of (1) to (7), comprising:
a lower jaw parameter calculation unit that calculates a motion of the lower jaw on a basis of coordinate information of a jaw opening/closing estimation vertex group set for the face mesh.
(9)

The information processing apparatus according to (8), wherein
the jaw opening/closing estimation vertex group includes one or more vertices located on the upper jaw and one or more vertices located on the lower jaw.
(10)

The information processing apparatus according to (8) or (9), wherein
the jaw opening/closing estimation vertex group includes a plurality of vertices located at a site where movement of skin is smallest when the jaw is opened and closed.
(11)

An information processing method executed by a computer, the method comprising:
fixing an upper vertex group of an oral mesh to a position of an upper jaw of a face mesh and deforming the oral mesh by moving a lower vertex group of the oral mesh in accordance with a motion of the lower jaw of the face mesh.
(12)

A computer-readable non-transitory storage medium storing a program for causing a computer to implement:
fixing an upper vertex group of an oral mesh to a position of an upper jaw of a face mesh and deforming the oral mesh by moving a lower vertex group of the oral mesh in accordance with a motion of the lower jaw of the face mesh.

### REFERENCE SIGNS LIST

10 INFORMATION PROCESSING APPARATUS
14 LOWER JAW PARAMETER CALCULATION UNIT
15 ORAL MESH DEFORMATION UNIT
16 MESH INTEGRATION UNIT
BG LOWER VERTEX GROUP
EG JAW OPENING/CLOSING ESTIMATION VERTEX GROUP
FM FACE MESH
LG LIP VERTEX GROUP
OM ORAL MESH
UG UPPER VERTEX GROUP

1. An information processing apparatus comprising:
an oral mesh deformation unit that fixes an upper vertex group of an oral mesh to a position of an upper jaw of a face mesh and deforms the oral mesh by moving a lower vertex group of the oral mesh in accordance with a motion of a lower jaw of the face mesh.

2. The information processing apparatus according to claim 1, wherein
the upper vertex group includes a vertex group of a part corresponding to a coupling portion between the upper jaw and the oral mesh.

3. The information processing apparatus according to claim 1, wherein
the lower vertex group includes a vertex group of a part corresponding to a coupling portion between the lower jaw and the oral mesh.

4. The information processing apparatus according to claim 3, wherein
the lower vertex group includes a vertex group of a part corresponding to a suprahyoid muscle group.

5. The information processing apparatus according to claim 4, wherein
the oral mesh deformation unit imparts a motion imitating a motion of the suprahyoid muscle group to the vertex group of the part corresponding to the suprahyoid muscle group.

6. The information processing apparatus according to claim 1, wherein
the oral mesh deformation unit sets a lip vertex group moved in accordance with a motion of a lip portion of the face mesh and the lower vertex group moved in accordance with the motion of the lower jaw as a control point group, and moves a peripheral vertex of the oral mesh around the control point group.

7. The information processing apparatus according to claim 1, comprising:
a mesh integration unit that integrates the face mesh and the oral mesh with reference to a vertex group of a lip portion located at a boundary between the face mesh and the oral mesh.

8. The information processing apparatus according to claim 1, comprising:
a lower jaw parameter calculation unit that calculates a motion of the lower jaw on a basis of coordinate information of a jaw opening/closing estimation vertex group set for the face mesh.

9. The information processing apparatus according to claim 8, wherein
the jaw opening/closing estimation vertex group includes one or more vertices located on the upper jaw and one or more vertices located on the lower jaw.

10. The information processing apparatus according to claim 8, wherein
the jaw opening/closing estimation vertex group includes a plurality of vertices located at a site where movement of skin is smallest when the jaw is opened and closed.

11. An information processing method executed by a computer, the method comprising:
fixing an upper vertex group of an oral mesh to a position of an upper jaw of a face mesh and deforming the oral mesh by moving a lower vertex group of the oral mesh in accordance with a motion of the lower jaw of the face mesh.

12. A computer-readable non-transitory storage medium storing a program for causing a computer to implement:
fixing an upper vertex group of an oral mesh to a position of an upper jaw of a face mesh and deforming the oral mesh by moving a lower vertex group of the oral mesh in accordance with a motion of the lower jaw of the face mesh.
